(19) United States
(12) Patent Application Publication
(10) Pub. No.: US 2004/0047485 A1
(43) Pub. Date: Mar. 11, 2004

(54) Folded horns for vibration actuators

(76) Inventors: Stewart Sherrit, La Crescenta, CA (US); Stephen A. Askins, Ledyard, CT (US); Michael James Gradziel, Cheshire, MA (US); Benjamin Dolgin, Los Angeles, CA (US); Yoseph Bar-Cohen, Seal Beach, CA (US); Xiaoqi Bao, San Gabriel, CA (US); Zensheu Chang, Irvine, CA (US); Thomas M. Peterson, Erie, PA (US)

Correspondence Address: Stewart Sherrit, 4325 Dunsmore Ave., La Crescenta, CA, 91214, US

(21) Appl. No.: 10/612,260

(22) Filed: Jul. 3, 2003

Related U.S. Application Data
(60) Provisional application No. 60/395,805, filed on Jul. 16, 2002.

(51) Int. Cl. H04R 1/02; H04R 1/20

(52) U.S. Cl. 381/340; 381/341

(57) ABSTRACT

The present invention provides a design of a horn for vibration actuators. In general a driving actuator generates vibrations and a horn amplifies the vibration amplitude where the amplification is related to the ratio between the surface area of the horn at the contact with the actuator and the tip surface. The acoustic path of existing direct horn designs is modified to adopt at least one change in direction, or fold, so as to produce a compact design Preferably there are three parallel, concentric, acoustic paths and two folds. A second embodiment has an internal horn that is concentric and internal to the actuator. A third embodiment uses a tubular horn where an electroactive stack is encircled by the horn. The device may have a hollow core for the transfer of materials from one side to the other. The addition of the folds to the horn allows for the introduction of constructive bending vibrations that can be used to enhance the amplification or to alter the phase of the vibration, and therefore provide an additional degree of freedom in the design of horns. The object of this invention is to provide for the design of compact configurations of vibration mechanisms, which are lightweight, compact and can be manufactured with a minimum of waste during fabrication.

This application claims the benefit of U.S. Provisional Patent Application No. 60/395,805 filed on Jul. 16, 2002 and entitled “Novel ultrasonic horns for power ultrasonics.”

### BACKGROUND OF THE INVENTION

1. Field of the Invention

The present invention relates to high power ultrasonic apparatus and acoustic vibration actuation devices. Specifically to the vibration amplifier, referred to as a “horn”, that is used to amplify the amplitude of vibrations that are produced by piezoelectric or electrostrictive actuators. The present invention is comprised of novel horn designs that achieve a compact overall length by incorporating at least one, but possibly many, changes in direction along the acoustic path, referred to as “folds”.

2. Background of the Invention

Acoustic horns are material configurations that amplify the induced amplitude from vibration actuation mechanisms. Generally, horns are used in many applications that require high power ultrasonic vibrations. Applications include automotive, actuation instruments, foods, medical, textiles, material joining, fabrication and cleaning industries. Horns are one of the three main components of vibration actuators operated from acoustic to ultrasonic frequency ranges. The other two main components consist of a stack of piezoelectric or electrostrictive elements and a backing material. An actuator stack is held in compression by a stress bolt that joins the backing of the stack to the horn. The horn is the component that amplifies the cyclic mechanical energy produced by the stack of piezoelectric or electrostrictive elements. The horn is placed in direct contact with the stack and amplifies the induced cyclic strain. Existing horns are made of a continuous solid material having a length that is determined by the operation frequency of the stack and the properties of the horn material so as to produce a resonance. These existing horns generally have two distinct cross-sectional areas, usually with a taper between them, with the larger area, or input area, facing the actuation stack. The change in area is used to amplify the limited displacement that is induced by the stack. Existing horns are configured as a direct transition between the input and output surface areas. In this disclosure, since there is a direct transition between the surface areas, existing horns are termed “direct horns” to clarify the configuration distinction between them and the disclosed embodiments. The design of direct horns has changed very little since they were first conceived. The amplification of the induced strain that occurs in a horn is a function of the ratio of diameters at the base and the tip. Driving the actuator at the frequency of mechanical resonance of the actuator including horn further amplifies the strain. The resonance amplification is determined by the mechanical Q factor (inverse of attenuation) of the horn material whereas the horn length primarily determines the resonance frequency. Because the overall length is equal to the acoustic length, the size of direct horns is driven by resonance considerations. For example, a stepped horn was made of titanium that was operated at resonance frequency of 22 kHz and had half wavelength length of approximately 8-cm. Although the direct horns are found in many current industrial designs their relatively long shape is a limitation that constrains the possible applications. Applications that require a lower vibration frequency require a large acoustic length and the resulting length of direct horns may be unacceptable. Even in horns that are fractions of meters long, this length can cause a significant limitation to applications where short length is critically needed for both volume and balance considerations. In addition to this limitation, producing a long direct horn requires excessive waste of material and production time for the removal of the excess material.

It is the object of this invention to provide piezoelectrically or electrostrictively driven vibration horns in a compact configuration. In addition, it is the object of this invention to provide a device that is lightweight and compact with comparable vibration amplitudes to existing direct horns. This invention consists of novel horn designs that incorporate one or more changes in direction, or bends, in the acoustic path. These changes of direction are termed “folds.” The resulting horn is referred to as a “folded horn.” Embodiments of this invention described herein are a doubly-folded horn, an internal horn, and an external horn The addition of the folds to the horn allows for the introduction of constructive bending vibrations that can be used to enhance the amplification of the actuation or to alter its phase.

### SUMMARY OF THE INVENTION

This invention is a horn with hollow configurations that amplifies vibrations produced by a vibration source. The horn consists of three embodiments that include internal, external and doubly folded configurations. It amplifies actuation from a vibration source such as a stack of piezoelectric or electrostrictive elements. The invention is a modification of direct horns that provides for lightweight and compact actuation mechanisms. The overall length is reduced by adopting at least one change in direction of the acoustic path. These changes in direction, or folds, will result in parallel acoustic paths. In the disclosed embodiments these paths are concentric to one another. This invention provides additional degrees of freedom in horn design and additional design options that include the ability to have the actuator encircled by the horn. Also, the folded horn can be configured in axis-symmetric and planar shapes to provide manufacturing flexibility. In addition, the use of reflectors at the folds allow for control of the phase of the reflected strain wave. The use of the folds allows for the introduction of constructive bending vibrations that enhance the amplification of the actuation. The use of holes along the center of the horn, actuator elements, stress bolt and backing allow for the movement of material between the horn tip and backing.

### BRIEF DESCRIPTION OF THE DRAWINGS

The invention will be more fully understood from the following detailed description of representative embodiments shown in the accompanying drawings and described in the following text.

FIG. 1 is a cross sectional view of an existing direct actuator (prior art).

FIG. 2 is a cross sectional view of a doubly folded actuator.

FIG. 3 is a cross sectional view of an internal horn actuator.

FIG. 4 is a cross sectional view of an external horn actuator.

FIG. 5 is a perspective view of an axis-symmetric folded horn in an actuator configuration.

FIG. 6 is a cross sectional view of an axis-symmetric folded horn.

FIG. 7 is a perspective and two section views of a planar folded horn.

### DETAILED DESCRIPTION OF THE PREFERRED EMBODIMENT

In the following description of the preferred embodiment, reference is made to the accompanying drawings, which form a part thereof, and in which by way of illustration, a specific embodiment in which the invention may be practiced. It is to be understood that other embodiments may be utilized and structural or material changes may be made without departing from the scope of the present invention.

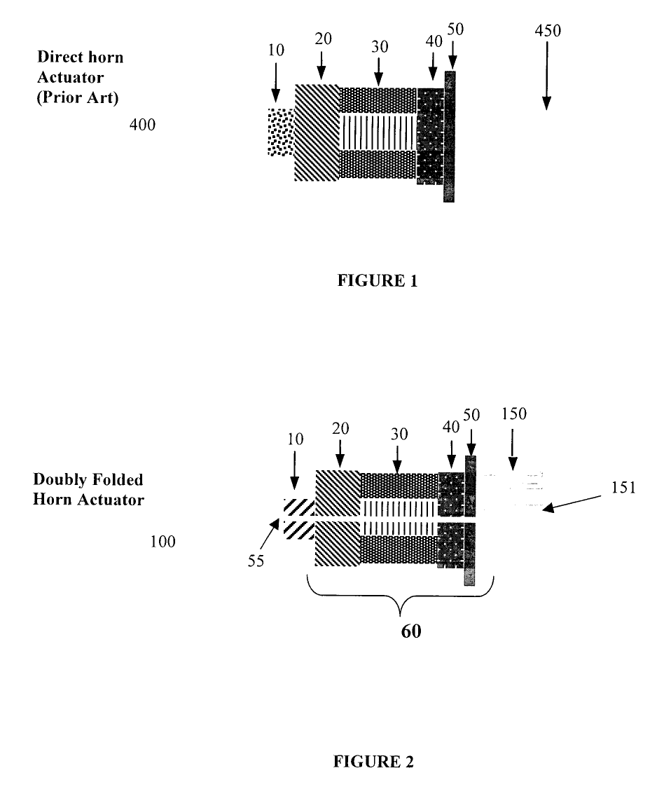

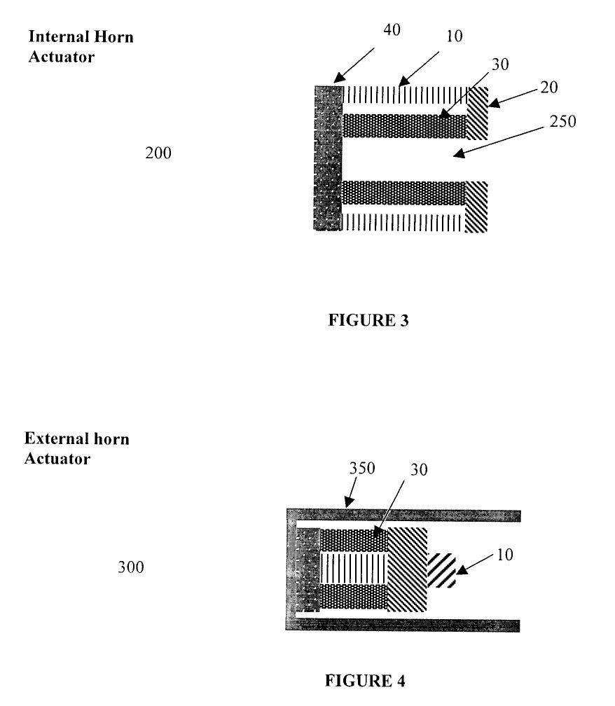

FIG. 1 is a cross sectional view of a direct horn 400 actuator with the direct horn 450 (prior art). FIG. 2 is a cross sectional view of a doubly folded horn actuator 100 and the doubly folded horn 150. FIG. 3 is a cross sectional view of an internal horn actuator 200 with the internal horn 250. FIG. 4 is a cross sectional view of an external horn actuator 300 and the external horn 350. The actuator components 60 shown in FIG. 2. are the same for all the horn actuator configurations and consist of a stress bolt 10 that maintains the piezoelectric or electrostrictive actuator stack 30 under compression and is connected to the front section of the actuator 40, 50 and 150. A backing 20 is used in the actuator to channel the induced vibration power forward so that it will be efficiently emitted from the tip of the horn 151. In order to provide space for the transfer of materials from the front of the actuator to the back through the device and a provide conduit for wiring a hollow core 55 could be machined through the center of the stress bolt 10 and the horn 150 or 250. The specific dimensions of this passage are determined by the applications for which the actuator is to be used.

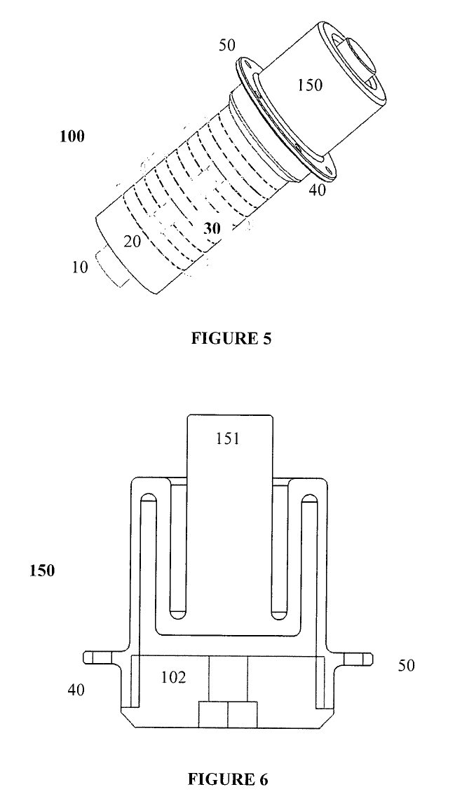

The following is a detailed description of the preferred embodiment of the doubly-folded horn. In this disclosed embodiment a folded horn actuator 100, shown in FIG. 5 in a perspective view and a folded horn 150 in FIG. 6 in cross-section view, consists of a configuration that induces mechanical vibrations from the actuator stack 30 that are amplified by the horn configuration of having large area on the stack side 102 and a small diameter on the tip side 151. To allow for parallel, concentric acoustic paths, the horn begins as a hollow shell. At one-third the acoustic length this shell is folded back towards the base and the thickness of this length of shell is adjusted to maintain the same area ratio. Then as the horn approaches the base it is turned once again to form a solid tip 151, producing an overall length that is approximately ⅓ that of a direct horn. Since the horn 150 is operated at its resonance frequency, and the total length is less than a wavelength (actually π/2), the folds to a first approximation have no affect on the resonance frequency or magnification of the horn. Therefore, the device shown in FIG. 5 allows for the manufacturing of horns of much shorter length with the same resonance frequency, and therefore the same performance, as an equivalent direct horn. Although FIG. 6 shows an embodiment with two folds, embodiments are also possible with a larger numbers of folds, and these embodiments are understood to be within the scope of the invention.

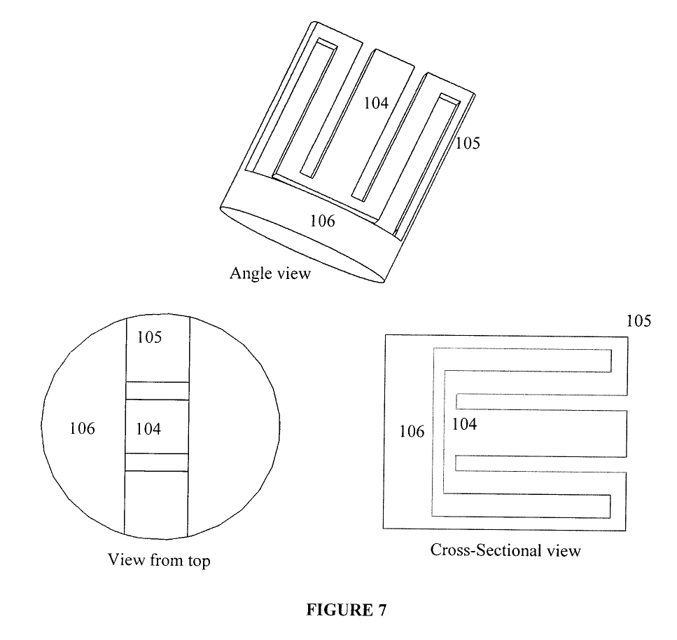

The displacement of the horn tip is the result of the longitudinal strain in the material. In a folded horn as is shown in FIG. 5 the tip displacement can be further adjusted by including bending displacements. This embodiment is shown in FIG. 7 where a planar configuration is shown. By adjusting the fold thickness 104 and 105, one can increase or decrease the bending contributions to the tip displacement. This gives the horn designer another degree of freedom in the horn design. Other embodiments of the disclosed invention include the internal horn and the external horn as are shown in FIG. 3 and FIG. 4. In these embodiments the actuator is concentric to the horn to produce a compact formation.

What is claimed is:

1. An apparatus that amplifies vibrations that are produced by an actuator, comprising;
a. a horn that forms two or more parallel acoustic paths and possesses two surfaces perpendicular to the extension, one connected directly to an actuator for mechanical input power and the other free for mechanical power output,
b. a horn with at least one change in direction that amplifies the vibration strain from an actuator.

2. The horn of claim 1, where the folded horn is configured axis-symmetric or planar with respect to axis of extension.

3. The horn of claim 1, further comprising of a stack of piezoelectric or electrostrictive elements that are configured concentric and external to the horn.

4. The horn of claim 1, comprised of an electroactive stack that is encircled by the horn as a compact modality of the actuator.

5. The horn of claim 1, comprised of a hollow core as a passage for transfer of materials from one side to the other.

6. The folded horn of claim 2, further comprising an adjustable fold thickness design for adjusting the bending contribution to the overall extension.

7. The folded horn of claim 2, further comprising of a reflector connected to the base of the folds for enhanced vibration amplification and control of the phase of the strain.
